(19) United States
(12) Patent Application Publication
(10) Pub. No.: US 2009/0039645 A1
(43) Pub. Date: Feb. 12, 2009

(54) FITTING AND TUBE ASSEMBLY FOR REFRIGERATION SYSTEMS

(76) Inventor: Serge Dube, St-Zotique (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/183,569

(22) Filed: Jul. 31, 2008

Related U.S. Application Data
(60) Provisional application No. 60/955,101, filed on Aug. 10, 2007.

(51) Int. Cl. F16L 55/00; B23P 11/00

(52) U.S. Cl. 285/39; 29/428

(57) ABSTRACT

A tube and fitting assembly for refrigeration systems comprises a tube having a connection end and receiving a flow of refrigerant. A fitting has a tubular body with a connector portion adapted to sealingly connect the fitting to a device. The connector portion has a seat portion having a shape complementary to that of a connector end of the device to form a sealing surface therewith. A sealing portion projects from the connector portion to form a sleeve about a portion of the tube. A weld seam is provided between the sealing portion and the tube.

### CROSS-REFERENCE TO RELATED APPLICATION

This patent application claims priority on U.S. Provisional Patent Application No. 60/955,101, filed on Aug. 10, 2007.

### FIELD OF THE APPLICATION

The present application relates to refrigeration systems and more particularly to fittings and tubes used in refrigerant networks of refrigeration systems.

### BACKGROUND OF THE ART

Referring to FIGS. 1 and 2, a fitting and tube assembly in accordance with the prior art is illustrated. A fitting 10 is mounted at a free end of a tube 12. The tube 12 has a flared end 14 that is seated in a corresponding countersink (not shown) in the fitting 10. The fitting 10 is connected to a device such as a valve by tapping 16 adjacent to the countersink in the cavity of the fitting 10. The valve has a tapered connection of shape matching that of the flared end 14. Therefore, the flared end 14 is sandwiched between the valve connector and the countersink, forming a sealing interface between the fitting 10, the tube 12 and the valve, to generally prevent leaks through the fitting and tube assembly.

The tube 12 is deformed to define the flared end 14, thereby weakening the tube 12 at the flared end 14. Accordingly, the flared end 14 of the tube 12 has been known to crack over time, for instance by the frequent flow of refrigerant as well as the pressures involved in refrigeration systems. Leaks often result from such cracks.

### SUMMARY OF THE APPLICATION

It is therefore an aim of the present disclosure to provide a novel fitting and tube assembly for refrigeration systems.

Therefore, in accordance with the present application, there is provided a tube and fitting assembly for refrigeration systems, comprising: a tube having a connection end and receiving a flow of refrigerant; a fitting having a tubular body with a connector portion adapted to sealingly connect the fitting to a device, the connector portion having a seat portion having a shape complementary to that of a connector end of the device to form a sealing surface therewith, and a sealing portion projecting from the connector portion to form a sleeve about a portion of the tube; and a weld seam between the sealing portion and the tube.

Further in accordance with the present application, there is provided a method for joining a tube to a connector of a refrigerant valve with a fitting, comprising: positioning the fitting about the connector of the refrigerant valve to abut an end of the connector against a sealing surface within the fitting; inserting the tube into a free end of the fitting; and performing a welding seam at a junction between a tip of the free end of the fitting and a peripheral surface of the tube; whereby the tube and the refrigerant valve are sealingly connected to one another.

### BRIEF DESCRIPTION OF THE DRAWINGS

FIG. 1 is a perspective view of a fitting and tube assembly in accordance with the prior art;

FIG. 2 is a perspective view of the fitting of the assembly of FIG. 1;

FIG. 3 is a perspective view of a fitting of a fitting and tube assembly in accordance with the present disclosure;

FIG. 4 is a sectional view of the fitting of FIG. 3; and

FIG. 5 is a sectional of the fitting of FIG. 4, in relation with a tube and a device connector.

### DESCRIPTION OF THE PREFERRED EMBODIMENTS

Referring now to FIGS. 3 to 5, a fitting used in a fitting and tube assembly in accordance with a preferred embodiment is generally shown at 20. The fitting 20 is used to interconnect a tube to a device such as a valve, or other devices used in refrigeration systems.

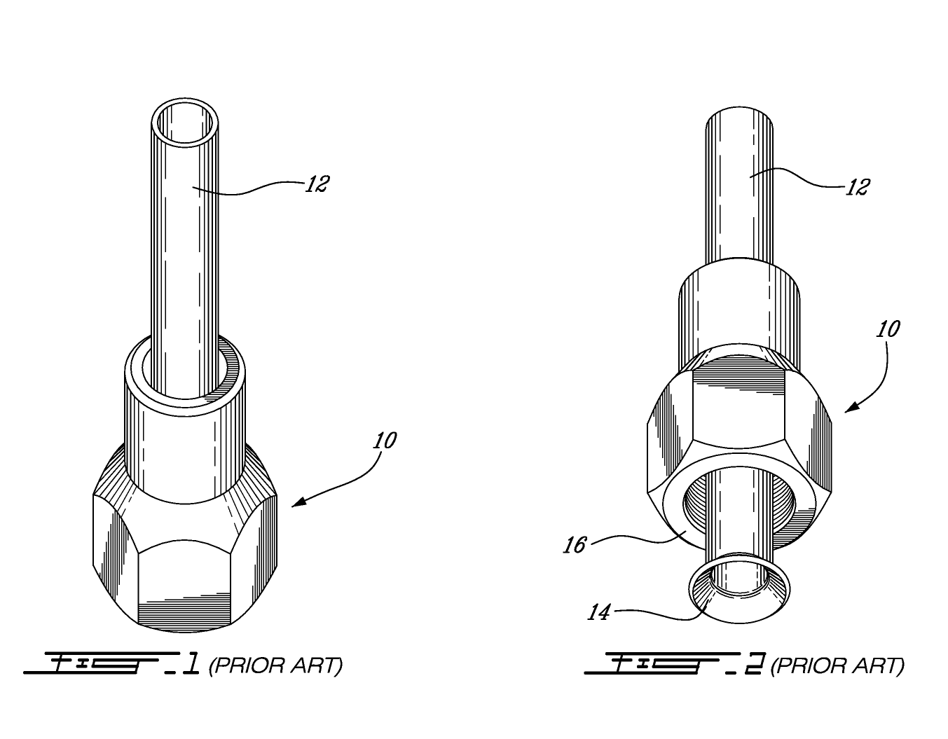

The fitting 20 has a connector portion 21 and a sealing portion 22. The connector portion 21 is provided to connect the fitting 20 to the device. The sealing portion 22 is provided to sealingly connect the fitting 20 to a tube (e.g., the tube 12 of FIG. 1, but without flared end 14).

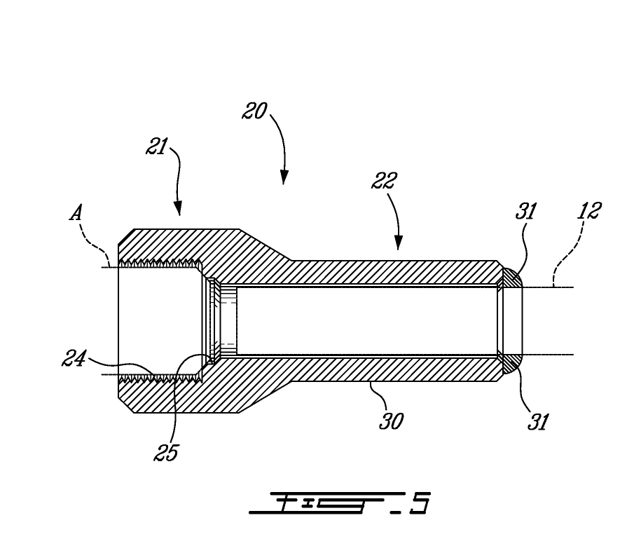

The connector portion 21 has a head 23 that is typically shaped to be compatible with tightening tools. For instance, as shown in FIGS. 3 and 4, the head 23 is in the shape of a hexagonal nut for compatibility with tools such as a wrench. In the cavity of the fitting 20 opposite the head 23, tapping 24 is provided. Therefore, the fitting 20 can be screwed to the device by the combination of the head 23 and the tapping 24. Other fastener means and head shapes are considered.

The cavity of the fitting 20 defines a counterbore portion resulting from a reduction of diameter between the cavity of the connector portion 21 and the cavity of the sealing portion 22. A seat 25 of countersink shape is located at the junction of the cavities. When a tube is received in the fitting 20, the tube remains in the sealing portion 22. The combination of countersink and counterbore shapes are illustrated in FIGS. 3 to 5, and define an abutment surface for the valve connector. It is considered to provide a single one of theses shapes inside the fitting 20 according to the valve connector that will be used with the fitting 20. It is observed that the counterbore defines a shoulder about the countersink seat 25. This configuration ensures that when the fitting 20 is screwed to the device, a gap is provided between the device and the counterbore as illustrated in FIG. 5. This will ensure that the fitting 20 is sealingly engaged to the device, as debris therebetween can move to the gap.

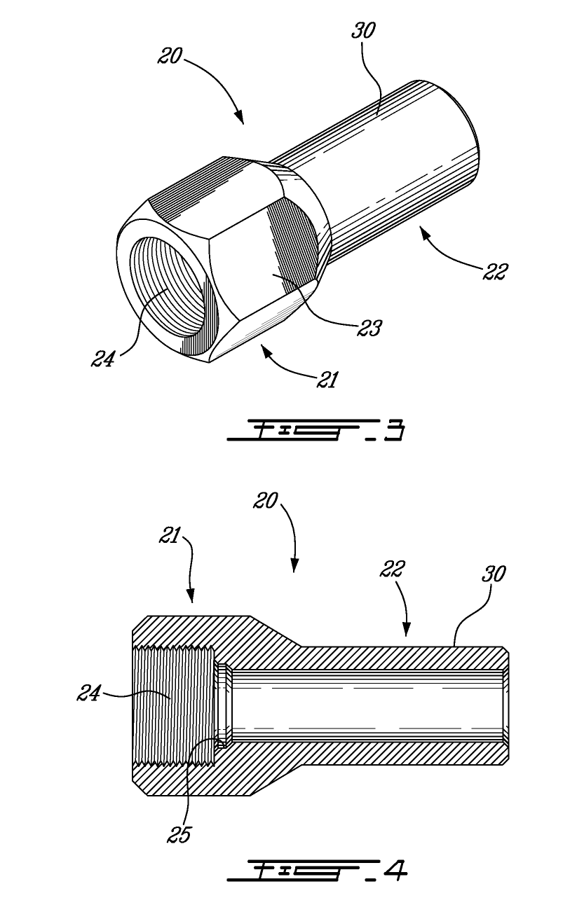

The sealing portion 22 has an elongated tubular portion 30 at the end of which a weld seam 31 is formed to seal off the junction between the fitting 20 and the tube. The sealing portion 22 therefore forms a sleeve about the tube. The weld seam 31 is formed peripherally about the tip of the sealing portion 22. The elongated tubular portion 30 must be of suitable length to avoid subjecting the connector portion 21 of the fitting 20 to the excessive heat involved in welding. It is known by a person skilled in the art that the sealing portion 22 and the tube 12 (FIGS. 1 and 2) are made of compatible materials so as to be welded to one another. For instance, materials that are well suited for use in refrigeration applications are brass and copper, but other materials are considered as well.

The fitting and tube assembly of the preferred embodiment, using the fitting 20, provides two different levels of sealing to prevent leaks of refrigerant. Firstly, a contact surface between the seat 25 and an end of the valve connector provides leakage prevention between the valve and fitting 20. Secondly, the weld seam 31 provides leakage prevention between the fitting 20 and the tube 12, as it surrounds the tip of the sealing portion 22 of the fitting 20.

In order to install the fitting and tip assembly to a device, it is suggested to initially connect the fitting 20 to a device. In the preferred embodiment, the fitting 20 is screwed to the device until the valve connector abuts the seat 25, as illustrated in FIG. 4, with the device connector illustrated as A. Thereafter, the weld seam 31 is formed between the fitting 20 and the tube.

1. A tube and fitting assembly for refrigeration systems, comprising:
a tube having a connection end and receiving a flow of refrigerant;
a fitting having a tubular body with a connector portion adapted to sealingly connect the fitting to a device, the connector portion having a seat portion having a shape complementary to that of a connector end of the device to form a sealing surface therewith, and a sealing portion projecting from the connector portion to form a sleeve about a portion of the tube; and
a weld seam between the sealing portion and the tube.

2. The assembly according to claim 1, wherein the seat portion is defined by a countersink position in the fitting.

3. The assembly according to claim 2, wherein the connector portion has a tapped counterbore adapted to be engaged on the connector end of the device, with the seat portion being at an end of the tapped counterbore in the fitting.

4. The assembly according to claim 1, wherein the connector portion has a hexagonal nut outer surface and tapping for threading engagement with the connector end of the device.

5. The assembly according to claim 1, wherein the device is a refrigerant valve.

6. A method for joining a tube to a connector of a refrigerant valve with a fitting, comprising:
positioning the fitting about the connector of the refrigerant valve to abut an end of the connector against a sealing surface within the fitting;
inserting the tube into a free end of the fitting; and
performing a welding seam at a junction between a tip of the free end of the fitting and a peripheral surface of the tube;
whereby the tube and the refrigerant valve are sealingly connected to one another.

7. The method according to claim 6, wherein positioning the fitting comprises screwingly engaging the fitting to the connector of the refrigerant valve.
